(19) United States
(12) Patent Application Publication
(10) Pub. No.: US 2024/0174293 A1
(43) Pub. Date: May 30, 2024

(54) STEERING DEVICE

(71) Applicant: HONDA MOTOR CO., LTD., Tokyo (JP)

(72) Inventor: Kotaro NAKAMURA, Tokyo (JP)

(21) Appl. No.: 18/522,260

(22) Filed: Nov. 29, 2023

(30) Foreign Application Priority Data
Nov. 30, 2022 (JP) 2022-191019

(51) Int. Cl. B62D 15/02; B62D 1/04

(52) U.S. Cl. CPC B62D 15/029; B62D 1/046; B62D 15/022

(57) ABSTRACT

A steering device (1) includes: a steering angle sensor (31); a grip sensor unit (8) which measures electrostatic capacitances of a plurality of electrodes (40) to (70) provided to the steering wheel (2), and acquires the presence/absence of gripping of the steering wheel (2) by the driver and the gripping position based on these measurement results of electrostatic capacitances; and an abnormality determination device (9) which determines presence/absence of abnormality in the grip sensor unit (8). The abnormality determination device (9) determines presence/absence of abnormality in the grip sensor unit (8), based on a straight grip position while going straight prior to a steering angle detection value exceeding a predetermined left-turn steering angle threshold (or right-turn steering angle threshold); and a left-turn grip position (or right-turn grip position) while turning after the steering angle detection value exceeded the left-turn steering angle threshold (or right-turn steering angle threshold).

This application is based on and claims the benefit of priority from Japanese Patent Application No. 2022-191019, filed on 30 Nov. 2022, the content of which is incorporated herein by reference.

### BACKGROUND OF THE INVENTION

### Field of the Invention

The present invention relates to a steering device. In more detail, it relates to a steering device which accepts a steering operation by a driver.

### Related Art

In recent years, endeavors have become more active to provide access to a sustainable transport system made in consideration of many people who are in a weak situation among traffic participants. Addressing the realization of this, the research and development for greatly improving the safety and convenience of traffic is given attention through the research and development related to driving aid functions such as a lane keeping function, lane departure prevention function, and preceding vehicle follow function.

With a vehicle equipped with such a driving aid function, in the case of determining the presence/absence of gripping of the steering wheel by the driver by way of a sensor device such as that shown in Patent Document 1, for example, and determining as not gripping, the driver may be prompted to grip the steering wheel, and cancelling the driving aid function during execution.

With the sensor device shown in Patent Document 1, the presence/absence of gripping of the steering wheel by the driver is determined based on the measurement value of the electrostatic capacitance of the electrodes provided to the steering wheel.
Patent Document 1: Japanese Unexamined Patent Application, Publication No. 2020-82821

### SUMMARY OF THE INVENTION

However, in the case of determining the presence/absence of gripping of the steering wheel based on the measurement value of electrostatic capacitance as in the invention disclosed in Patent Document 1, there is concern over the measurement value of electrostatic capacitance changing when moisture such as a drink or rainwater falling on the steering wheel, and misjudging. For this reason, in the case of an abnormality arising in the sensor device, it is necessary to rapidly detect this.

The present invention has an object of providing a steering device which can rapidly determine the presence/absence of abnormality in the grip sensor of the steering wheel, and thus has an object of contributing to the development of a sustainable transportation system.

A steering device according to a first aspect of the present invention includes: a steering wheel which accepts a steering operation of a vehicle from a driver; a steering angle acquirer which acquires a steering angle of the steering wheel; a grip sensor unit which measures electrostatic capacitance of an electrode provided to the steering wheel, and acquires presence/absence of gripping of the steering wheel and gripping position by a driver based on a measurement result of the electrostatic capacitance; and an abnormality determination device which determines presence/absence of abnormality in the grip sensor unit, in which the abnormality determination device determines presence/absence of abnormality in the grip sensor unit based on the gripping position while going straight prior to the steering angle exceeding a predetermined steering angle threshold, and the gripping position while turning after the steering angle exceeded the steering angle threshold.

According to a second aspect of the present invention, in this case, it is preferable for the abnormality determination device to determine that the grip sensor unit is abnormal, in a case of the gripping position while going straight being a first position, and the gripping position while turning including both the first position and a second position differing from the first position.

According to a third aspect of the present invention, in this case, it is preferable for the steering wheel to include an annular rim part, a hub part provided at an inner side of the rim part, and a spoke connecting the rim part and the hub part, in which the grip sensor unit acquires the gripping position on the rim part, and the second position is decided more to an opposite side to a turning direction than the first position on the rim part.

According to a fourth aspect of the present invention, in this case, it is preferable for the grip sensor unit to include: a first electrode provided to the steering wheel; a second electrode provided at a position on the steering wheel farther from the first position than the first electrode and closer to the second position; a first grip determiner which determines presence/absence of gripping at the first position on the rim part based on a measurement result of electrostatic capacitance of the first electrode; and a second grip determiner which determines presence/absence of gripping at the second position on the rim part based on a measurement result of electrostatic capacitance of the second electrode, in which the abnormality determination device invalidates determination result of the first grip determiner, in a case of the gripping position while going straight being the first position and the gripping position while turning including both the first position and the second position.

According to a fifth aspect of the present invention, in this case, it is preferable for the steering angle threshold to be set to an angle distanced by at least 90° from a neutral position.

In the first aspect of the present invention, the grip sensor unit measures the electrostatic capacitance of the electrodes to the steering wheel, acquires the presence/absence of gripping of the steering wheel and gripping position by the driver, based on the measurement results of these electrostatic capacitances, and the abnormality determination device determines the presence/absence of abnormality in the grip sensor unit. Herein, the driver often changes grip of the steering wheel from when going straight to when turning, upon rotating the steering wheel in the left-turn direction or right-turn direction for turning the vehicle. In other words, the gripping position while going straight before the steering angle detection value of the steering wheel exceeds the steering angle threshold often differs from the gripping position while turning after the steering angle detection value has exceeded the steering angle threshold. Therefore, the abnormality determination device determines the presence/absence of abnormality in the grip sensor unit, based on the gripping position while going straight, and the gripping position while turning. Consequently, according to the present invention, it is possible to quickly determine the presence/absence of abnormality in the grip sensor unit of the steering wheel with a simple configuration, and can contribute to the development of a sustainable transportation system.

According to the second aspect, when switching grip of the steering wheel from when going straight to when turning as mentioned above, the gripping position often differs between when going straight and when turning. Therefore, the abnormality determination device determines that the grip sensor unit is abnormal in the case of the gripping position while going straight being the first position and the gripping position while turning including both the first position and the second position, i.e. the first position being gripped also while turning, irrespective of the gripping position changing from the first position to the second position from when going straight to when turning. Consequently, according to the present invention, it is possible to quickly determine the presence/absence of abnormality in the grip sensor unit of the steering wheel with a simple configuration.

According to the third aspect, in the case of switching grip of the steering wheel as mentioned above, the driver often changes the gripping position on the annular rim part from while going straight to while turning to the opposite side than the turning direction, in order to reduce the extension of one's arm and the twist of the wrist, and avoid interference between the elbow and torso. In other words, in the case of rotating the rim part while turning left counter clockwise, the driver often changes the gripping position to a position distanced clockwise from the position while going straight. In other words, in the case of rotating the rim part clockwise while turning right, the driver often changes the gripping position to the position distanced counter clockwise from the position while going straight. Therefore, the abnormality determination device determines that the grip sensor unit is abnormal, in the case of the gripping position while going straight being the first position, and the gripping position while turning including both the first position and the second position which is decided more to the opposite side to the turning direction than the first position. Consequently, according to the present invention, it is possible to quickly determine the presence/absence of abnormality in the grip sensor unit of the steering wheel with a simple configuration.

According to the fourth aspect, the grip sensor unit includes: the first electrode provided at a position close to the first position; the second electrode provided at a position close to the second position; the first grip determiner which determines the presence/absence of gripping of the first position based on the measurement result of electrostatic capacitance of the first electrode; and the second grip determiner which determines the presence/absence of gripping of the second position based on the measurement result of electrostatic capacitance of the second electrode. In addition, the abnormality determination device determines that there is an abnormality in the first determiner of the grip sensor unit, in the case of the gripping position while going straight being the first position, and the gripping position while turning including both the first position and the second position, and then invalidates the determination results of the first grip determiner thereafter. It is thereby possible to guarantee reliability of determination results of the grip sensor unit after being determined that an abnormality occurred.

According to the fifth aspect the driver often switches grip of the steering wheel while rotating the steering wheel from the neutral position by at least 90° to the left-turn direction or right-turn direction. Therefore, in the present invention, it is possible to precisely determine abnormality in the grip sensor unit, by setting the steering angle threshold to an angle distancing at least 90° from the neutral position.

### BRIEF DESCRIPTION OF THE DRAWINGS

FIG. 1 is a view showing the configuration of a steering device according to a first embodiment of the present invention;

FIG. 2 is a view showing a circuit configuration of a right-measurement circuit;

FIG. 3A is a view showing a typical gripping position of a rim part by a driver while going straight;

FIG. 3B is a view showing a typical gripping position of a rim part by a driver while turning left;

FIG. 3C is a view showing a typical gripping position of a rim part by a driver while turning right;

FIG. 4 is a flowchart (1 of 3) showing a specific sequence of abnormality determination processing of an abnormality determination device;

FIG. 5 is a flowchart (2 of 3) showing a specific sequence of abnormality determination processing of an abnormality determination device; and

FIG. 6 is a flowchart (3 of 3) showing a specific sequence of abnormality determination processing of an abnormality determination device.

### DETAILED DESCRIPTION OF THE INVENTION

Hereinafter, a steering device according to an embodiment of the present invention will be explained while referencing the drawings.

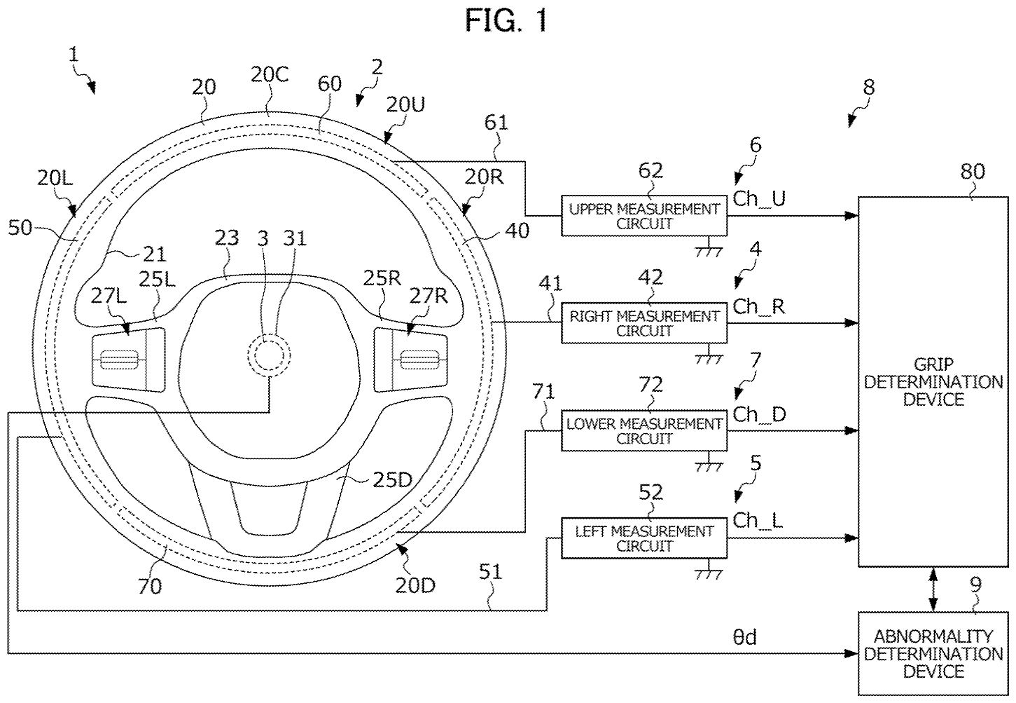

FIG. 1 is a view showing the configuration of a steering device 1 according to the present embodiment. The steering device 1 is equipped to a vehicle (not shown). The steering device 1 includes: a steering wheel 2 which accepts steering operation of the vehicle by the driver and auxiliary device operation related to a vehicle auxiliary device; a steering shaft 3 that pivotally supports this steering wheel 2; a grip sensor unit 8 which acquires the presence/absence of gripping of the steering wheel 2 by the driver and the gripping position based on the measurement results of the electrostatic capacitance of a plurality of electrodes provided to the steering wheel 2; and an abnormality determination device 9 which determines the presence/absence of an abnormality in this grip sensor unit 8.

The steering wheel 2 includes a rim part 20 which can be gripped by the driver and is annular; a hub part 23 provided on the inner side of this rim part 20; and three spokes 25L, 25R, 25D connected to a rim inner circumferential part 21 of the rim part 20 extending along the radial direction from the hub part 23.

The hub part 23 is cylindrical, is provided at the center of the rim part 20 viewed from the driver, for example, and configures a center of the steering wheel 2. At a back side of the hub part 23 viewed from the driver, a steering shaft 3 which pivotally supports the steering wheel 2 is coupled. The steering shaft 3 is a rod-like coupling member which couples a core, which is the backbone of the hub part 23, and a steering mechanism which constitutes part of the vehicle frame which is not shown. Therefore, the steering torque generated by the driver rotating the steering wheel 2 is transferred to the steering mechanism, which is not shown, by this steering shaft 3.

To this steering shaft 3, a steering angle sensor 31 which detects the steering angle of the steering wheel 2, and outputs a signal corresponding to the detection value to the abnormality determination device 9 is provided. It should be noted that, hereinafter, the steering angle when the steering wheel 2 is at a neutral position such as that shown in FIG. 1 is defined as 0°. In addition, the steering angle increases to the positive side when turning the steering wheel 2 from the neutral position to the left turn direction (counterclockwise in FIG. 1), and the steering angle increases to the negative side turning the steering wheel 2 from the neutral position to the right turn direction (clockwise in FIG. 1).

The rim part 20 and hub part 23 are connected by the three spokes 25L, 25R, 25D. The left spoke 25L extends along the horizontal direction, and connects a portion on the left side of the hub part 23 viewed from the driver, and a portion on the right side of the rim inner circumferential part 21 viewed from the driver. The right sport part 25R extends in parallel with the left spoke 25L along the horizontal direction, and connects a portion on the right side of the hub part 23 viewed from the driver, and a portion on the right side of the rim inner circumferential direction 21 viewed from the driver. The lower spoke 25D extends perpendicular to the spokes 25L, 25R along the vertical direction, and connects a portion on the lower part of the hub part 23 viewed from the driver, and a portion on a lower part of the rim inner circumferential part 21 viewed from the driver.

In the above way, the rim part 20 is annular viewed from the driver, and the driver can grip over the entire circumference thereof. In addition, the plurality of electrodes 40, 50, 60, 70 of the grip sensor unit 8 described later are provided over the entire circumference on this rim part 20.

At the left spoke 25L and right spoke 25R, a left auxiliary device operation control unit 27L and a right auxiliary device operation control unit 27R which accept auxiliary device operations from the driver in order for the driver to operate vehicle auxiliary devices, which are not shown (for example, audio deice, car navigation device, etc.), are provided. The driver becomes able to operate the vehicle auxiliary devices by operating a plurality of switches provided to these auxiliary device operation control units 27L, 27R by finger.

It should be noted that, hereinafter, the positions of the substantially circular rim part 20, rim inner circumferential part 21, hub part 23 and steering shaft 3, and orientations of each spoke 25L, 25R, 25D viewed from the driver may be represented by a clock-wise angle “°” centering around the steering shaft 3, and with the upper end part 20C of the rim part 20 viewed from the driver as a reference. In other words, the right spoke 25R extends along the orientation of 90°, and connects a 90° portion of the hub part 23 and rim inner circumferential part 21. The lower spoke 25D extends along an orientation of 180°, and connects a 180° portion of the hub part 23 and rim inner circumferential part 21. In addition, the left spoke 25L extends along the orientation of 270°, and connects a 270° portion of the hub part 23 and rim inner circumferential part 21.

The grip sensor unit 8 includes: a plurality (four in the present embodiment) of proximity sensors 4, 5, 6, 7 having respectively different detection target regions, and a grip determination device 80 which determines the presence/absence of gripping of the steering wheel 2 by the driver and the grip positions based on the measurement results from these proximity sensors 4 to 7.

The right proximity sensor 4 includes a right electrode 40 provided to the rim part 20, and a right measurement circuit 42 electrically connected with this right electrode 40. The right electrode 40 is a circular arc shape extending along the rim part 20, and is electrically conductive. The right electrode 40 is provided inside of the rim part 20. The right electrode 40 is arranged in a range of about 90° between 45° and 135° of the rim part 20 (i.e. range which can be gripped mainly by the right hand of the driver while going straight). It should be noted that, hereinafter, the region of the rim part 20 in which the right electrode 40 is arranged is also referred to as right grip part 20R. The right measurement circuit 42 is connected with the right electrode 40 via a wire 41. The right measurement circuit 42 measures electrostatic capacitance between the right electrode 40 and ground, as a value which fluctuates according to the distance between the arrangement position of the right electrode 40 and the human body. As the distance between the arrangement position of the right electrode 40 and human body narrows, the electrostatic capacitance between the right electrode 40 and ground becomes larger. A measurement value Ch_R of electrostatic capacitance by the right measurement circuit 42 is sent to the grip determination device 80.

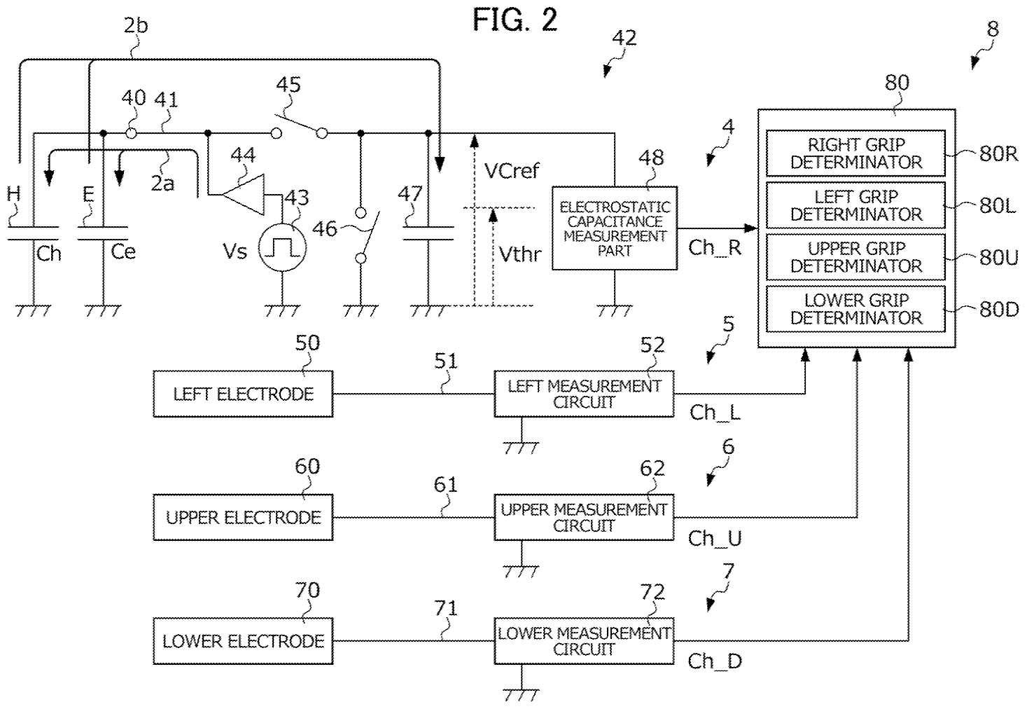

FIG. 2 is a view showing the circuit configuration of the right measurement circuit 42. The right measurement circuit 42 includes a pulse power source 43, amplifier 44, first switch 45, second switch 46, charge capacitor 47, and electrostatic capacitance measurement unit 48. It should be noted that FIG. 2 illustrates the electrostatic capacitance between the right electrode 40 and ground (for example, vehicle frame) to be divided into electrostatic capacitance Ch formed by the human body H including the hands of the driver operating the steering wheel 2, and the stray capacitance Ce formed by a floating capacitor E of wires, components, etc. excluding the human body H.

As shown in FIG. 2, the pulse power source 43 and amplifier 44 are connected in series. The second switch 46 and charge capacitor 47 are connected in parallel. A series circuit made from the pulse power source 43 and amplifier 44, and the parallel circuit made from the second switch 46 and charging capacitor 47 are connected via the first switch 45. An output terminal of the amplifier 44 and the first switch 45 are connected to the right electrode 40 via the wire 41. Therefore, the pulse power source 43 is connected to the right electrode 40 via the amplifier 44 and wire 41. In addition, the second switch 46 and charge capacitor 47 are connected to the right electrode 40 respectively via the first switch 45 and wire 41.

The pulse power source 43 supplies a pulse voltage Vs of predetermined frequency and predetermined voltage to the amplifier 44, in response to a command from the grip determination device 80. The amplifier 44 amplifies the pulse voltage Vs supplied from the pulse power source 43, and applies it to the right electrode 40.

The second switch 46 is a switching element which is turned ON/OFF by a drive circuit which is not illustrated. The drive circuit of this second switch 46 turns OFF the second switch 46 until the voltage VCref of the charge capacitor 47 reaches the threshold Vthr decided in advance, and turns ON the second switch 46 after the voltage VCref reaches the threshold Vthr, and discharges the charge stored in the charge capacitor 47.

The first switch 45 is a switching element which is turned ON/OFF by a drive circuit which is not illustrated. The drive circuit of this first switch 45 turns OFF the first switch 45 in response to rising of the pulse voltage Vs of the pulse power source 43. The pulse voltage supplied from the pulse power source 43 and amplifier 44 is applied to the right electrode 40, the charge migrates through the path shown by the arrow 2a in FIG. 2, and the human body H and floating capacitor E are thereby charged.

In addition, the drive circuit of the first switch 45 turns ON the first switch 45 in response to falling edge of the pulse voltage Vs of the pulse power source 43. The human body H and floating capacitor E and the charge capacitor 47 are thereby connected, charge migrates through the path shown by the arrow 2b in FIG. 2 from the human body H and floating capacitor E to the charge capacitor 47, and the charge capacitor 47 is charged. The voltage VCref of the charge capacitor 47 thereby rises.

For this reason, when applying the pulse voltage to the right electrode 40 by the pulse power source 43 and amplifier 44, charge and discharge of the human body H and floating capacitor E is alternately repeated, and the voltage VCref of the charge capacitor 47 gradually increases. At this time, the time until the voltage VCref of the charge capacitor 47 reaches the threshold Vthr (or pulse number of the pulse power source 43) varies according to the static capacitance Ch formed by the human body H, i.e. distance between the right electrode 40 and body of the driver. In other words, in the case of part of the body of the driver contacting or approaching the arrangement position of the right electrode 40 on the rim part 20, and the static capacitance Ch rising, the time taken until the voltage VCref of the charge capacitor 47 reaches the threshold Vthr shortens, and in the case of part of the body of the driver distancing from the arrangement position of the right electrode 40 and the static capacitance Ch lowering, the time taken until the voltage VCref of the charge capacitor 47 reaches the threshold Vthr lengthens.

The static capacitance measurement unit 48 measures the time and pulse number until the voltage VCref of the charge capacitor 47 reaches the threshold Vthr, and measures the static capacitance Ch formed by the human body H existing in the vicinity of the right electrode 40 indirectly based on this measurement result. The static capacitance measurement unit 48 sends a measurement value Ch_R of the static capacitance Ch obtained by the above sequence to the grip determination device 80.

Referring back to FIG. 1, the left proximity sensor 5 includes a left electrode 50 provided to the rim part 20, and a left measurement circuit 52 electrically connected with this left electrode 50. The left electrode 50 is a circular arc shape extending along the rim part 20, and is electrically conductive. The left electrode 50 is provided inside of the rim part 20. The left electrode 50 is arranged in the range of about 90° between 225° and 315° of the rim part 20 (i.e. range grippable mainly by the left hand of the driver while going straight). It should be noted that the region of the rim part 20 in which the left electrode 50 is arranged is also referred to as left grip part 20L below. The left measurement circuit 52 is connected with the left electrode 50 via the wire 51. The left measurement circuit 52 measures the static capacitance between the left electrode 50 and ground, as a value which varies according to the distance between the arrangement position of the left electrode 50 and the human body. As the distance between the arrangement position of the left electrode 50 and the human body approaches, the electrostatic capacitance between the left electrode 50 and ground increases. The measurement value Ch_L of the static capacitance by the left detection circuit 52 is sent to the grip determination device 80. It should be noted that the circuit configuration of the left measurement circuit 52 is substantially the same as the right measurement circuit 42 shown in FIG. 2, and thus detailed explanation thereof is omitted.

The upper proximity sensor 6 includes an upper electrode 60 provided to the rim part 20, and an upper measurement circuit 62 electrically connected with this upper electrode 60. The upper electrode 60 is a circular arc shape extending along the rim part 20, and is electrically conductive. The upper electrode 60 is provided inside of the rim part 20. The upper electrode 60 is arranged in a range of about 90° between 315° and 405° (45°) of the rim part 20 (i.e. range grippable by the right hand or left hand of the driver while turning). It should be noted that the region of the rim part 20 in which the upper electrode 60 is arranged is also referred to as rim part upper part 20U hereinafter. The upper detection circuit 62 is connected with the upper electrode 60 via a wire 61. The upper measurement circuit 62 measures the static capacitance between the upper electrode 60 and ground, as a value which varies according to the distance between the arrangement position of the upper electrode 60 and the human body. As the distance between the arrangement position of the upper electrode 60 and human body approaches, the static capacitance between the upper electrode 60 and ground increases. The measurement value Ch_U of static capacitance from the upper detection circuit 62 is sent to the grip determination device 80. It should be noted that the circuit configuration of the upper measurement circuit 62 is substantially the same as the right measurement circuit 42 shown in FIG. 2, and thus a detailed explanation is omitted.

The lower proximity sensor 7 includes a lower electrode 70 provided to the rim part 20, and a lower measurement circuit 72 electrically connected with this lower electrode 70. The lower electrode 70 is a circular arc shape extending along the rim part 20, and is electrically conductive. The lower electrode 70 is provided at the inner side of the rim part 20. The lower electrode 70 is arranged in a range of about 90° between 135° and 225° of the rim part 20 (i.e. grippable range by right hand or left hand of driver while going straight, and range of the rim part 20 closest to knees of driver). It should be noted that the region of the rim part 20 in which the lower electrode 70 is arranged is also referred to as lower grip part 20D hereinafter. The lower measurement circuit 72 is connected with the lower electrode 70 via a wire 71. The lower measurement circuit 72 measures the static capacitance between the lower electrode 70 and ground as a value which varies according to the distance between the arrangement position of the lower electrode 70 and the human body. As the distance between the arrangement position of the lower electrode 70 and the human body approaches, the static capacitance between the lower electrode 70 and ground increases. The measurement value Ch_D of static capacitance from the lower detection circuit 72 is sent to the grip determination device 80. It should be noted that the circuit configuration of the lower measurement circuit 72 is substantially the same as the right measurement circuit 42 shown in FIG. 2, and thus a detailed explanation is omitted.

In the above way, the right electrode 40 of the right proximity sensor 4 is provided at a position closer to the right grip part 20R than the other electrodes 50, 60, 70. For this reason, the right proximity sensor 4 defines the right grip part 20R of the rim part 20 as a detection target region. The left electrode 50 of the left proximity sensor 5 is provided at a position closer to the left grip part 20L than the other electrodes 40, 60, 70. For this reason, the left proximity sensor 5 defines the left grip part 20L of the rim part 20 as the detection target region. The upper electrode 60 of the upper proximity sensor 6 is provided at a position closer to the upper grip part 200 than the other electrodes 40, 50, 70. For this reason, the upper proximity sensor 6 defines the upper grip part 200 of the rim part 20 as a detection target region. The lower electrode 70 of the lower proximity sensor 7 is provided at a position closer to the lower grip part 20D than the other electrodes 40, 50, 60. For this reason, the lower proximity sensor 7 defines the lower grip part 20D of the rim part 20 as a detection target region. The grip determination device 80 acquires the presence/absence of gripping of the rim part 20 by the driver and the gripping position, based on each of the measurement values Ch_R, Ch_L, Ch_U and Ch_D of the four proximity sensors 4 to 7 having different detection target regions on the rim part 20 as mentioned above.

As shown in FIG. 2, the grip determination device 80 includes: a right grip determiner 80R which determines the presence/absence of gripping of the right grip part 20R of the rim part 20, based on the measurement value Ch_R of electrostatic capacitance of the right electrode 40 outputted from the right proximity sensor 4; a left grip determiner 80L which determines the presence/absence of gripping of the left grip part 20L of the rim part 20, based on the measurement value Ch_L of electrostatic capacitance of the left electrode 50 outputted from the left proximity sensor 5; an upper grip determiner 80U which determines the presence/absence of gripping of the upper grip part 20U of the rim part 20, based on the measurement value Ch_U of electrostatic capacitance of the upper electrode 60 outputted from the upper proximity sensor 6; and a lower grip determiner 80D which determines the presence/absence of gripping of the lower grip part 20D of the rim part 20, based on the measurement value Ch_D of electrostatic capacitance of the lower electrode 70 outputted from the lower proximity sensor 7.

The right grip determiner 80R determines that the rim part 20 is being gripped by the driver at the right grip part 20R, in the case of the measurement value Ch_R being greater than a right electrostatic capacitance threshold value Ch_R_th set in advance, and determines that the rim part 20 is not being gripped by the driver at the right grip part 20R, in the case of the measurement value Ch_R being less than the right electrostatic capacitance threshold value Ch_R_th.

The left grip determiner 80L determines that the rim part 20 is being gripped by the driver at the left grip part 20L, in the case of the measurement value Ch_L being greater than a left electrostatic capacitance threshold value Ch_L_th set in advance, and determines that the rim part 20 is not being gripped by the driver at the left grip part 20L, in the case of the measurement value Ch_L being less than the left electrostatic capacitance threshold value Ch_L_th.

The upper grip determiner 80U determines that the rim part 20 is being gripped by the driver at the upper grip part 20U, in the case of the measurement value Ch_U being greater than a upper electrostatic capacitance threshold value Ch_U_th set in advance, and determines that the rim part 20 is not being gripped by the driver at the upper grip part 20U, in the case of the measurement value Ch_U being less than the upper electrostatic capacitance threshold value Ch_U_th.

The lower grip determiner 80D determines that the rim part 20 is being gripped by the driver at the lower grip part 20D, in the case of the measurement value Ch_D being greater than a lower electrostatic capacitance threshold value Ch_D_th set in advance, and determines that the rim part 20 is not being gripped by the driver at the lower grip part 20D, in the case of the measurement value Ch_D being less than the lower electrostatic capacitance threshold value Ch_D_th.

Referring back to FIG. 1, the abnormality determination device 9 determines the presence/absence of abnormality in the grip sensor unit 8 based on the steering angle detection value Od outputted from the steering angle sensor 31; and the determination results such as the presence/absence of gripping, gripping position, etc. of the grip sensor unit 8.

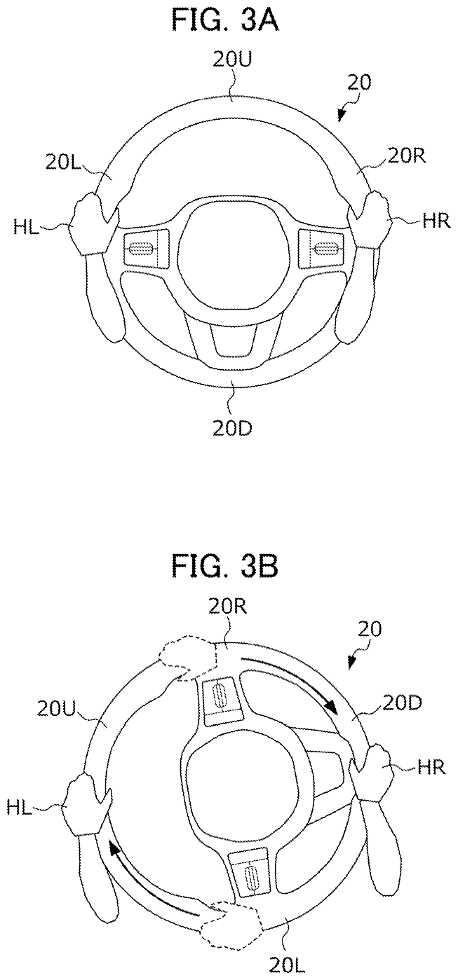

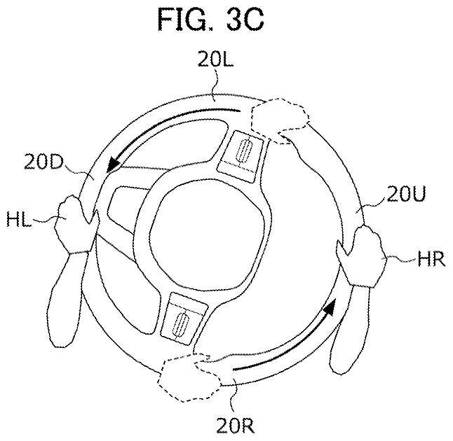

FIG. 3A is a view showing typical gripping positions of the rim part 20 by the driver while going straight. As shown in FIG. 3A, the driver often grips the right grip part 20R by the right hand HR, and grips the left grip part 20L by the left hand HL, while going straight, i.e. when maintaining the steering wheel 2 in the neutral position.

FIG. 3B is a view showing typical grip positions of the rim part 20 by the driver while turning left. As shown in FIG. 3B, during left turn, the driver causes the rim part 20 to rotate by at least 90° counter clockwise from the neutral position. At this time, when rotating the rim part 20 by about 90° counter clockwise while gripping the right grip part 20R with the right hand HR and the left grip part 20L with the left hand HL as shown in FIG. 3A, since the extension of the arm and twist of the wrist increases, and the elbow interferes with the torso, most drivers switch grips of the right hand HR and left hand HL as shown in FIG. 3B. In other words, the right hand HR gripping the right grip part 20R while going straight switches grip to the lower grip part 20D more to the clockwise side than the right grip part 20R while turning left. In addition, the left hand HL gripping the left grip part 20L while going straight switches to the upper grip part 20U more to the clockwise side than the left grip part 20L while turning left.

FIG. 3C is a view showing the typical grip positions of the rim part 20 by the driver while turning right. While turning right as shown in FIG. 3C, the driver causes the rim part 20 to rotate by at least 90° clockwise from the neutral position. At this time, when rotating the rim part 20 by at least 90° clockwise while gripping the right grip part 20R with the right hand HR and gripping the left grip part 20L with the left hand HL as shown in FIG. 3A, since the extension of the arm and twist of the wrist increases, and the elbow interferes with the torso, most drivers switch grips of the right hand HR and left hand HL as shown in FIG. 3C. In other words, the right hand HR gripping the right grip part 20R while going straight switches to the upper grip part 20U more to the counter clockwise side than the right grip part 20R, while turning right. In addition, the left hand HL gripping the left grip part 20L while going straight switches to the lower grip part 20D more to the counter clockwise side than the left grip part 20L while turning right.

In the above way, the driver often switch grips on the rim part 20 from when going straight to when turning, upon causing the rim part 20 to rotate by at least 90° towards the left turn direction or right turn direction in order to turn the vehicle. The abnormality determination device 9 determines the presence/absence of abnormality in the grip sensor unit 8 by using a grip change of the rim part 20 by the driver while turning.

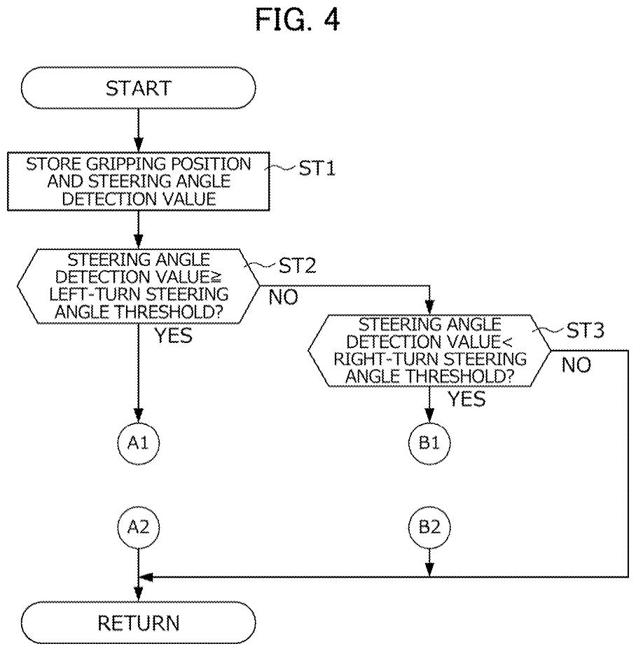

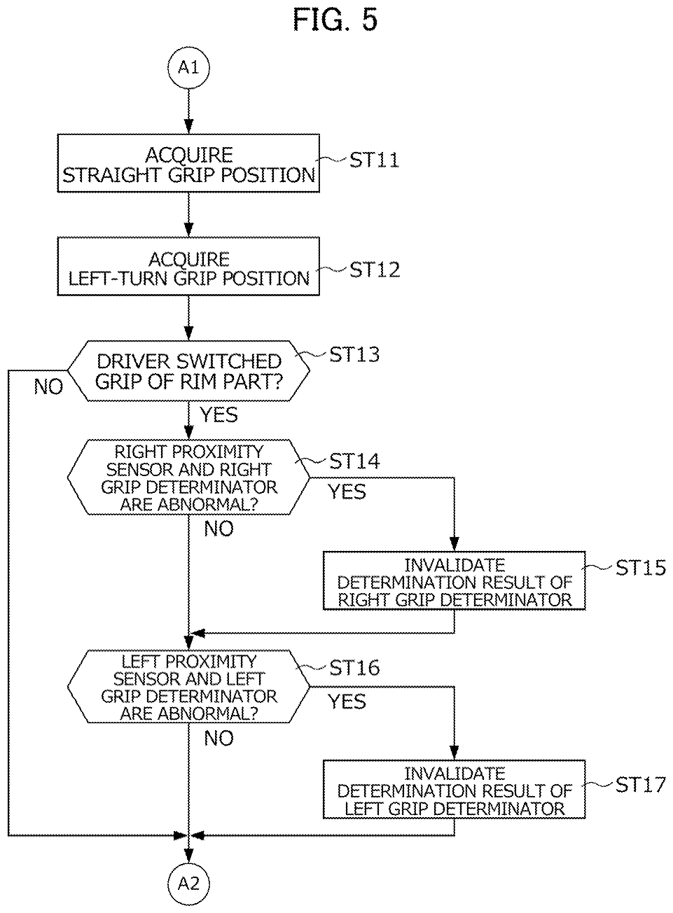

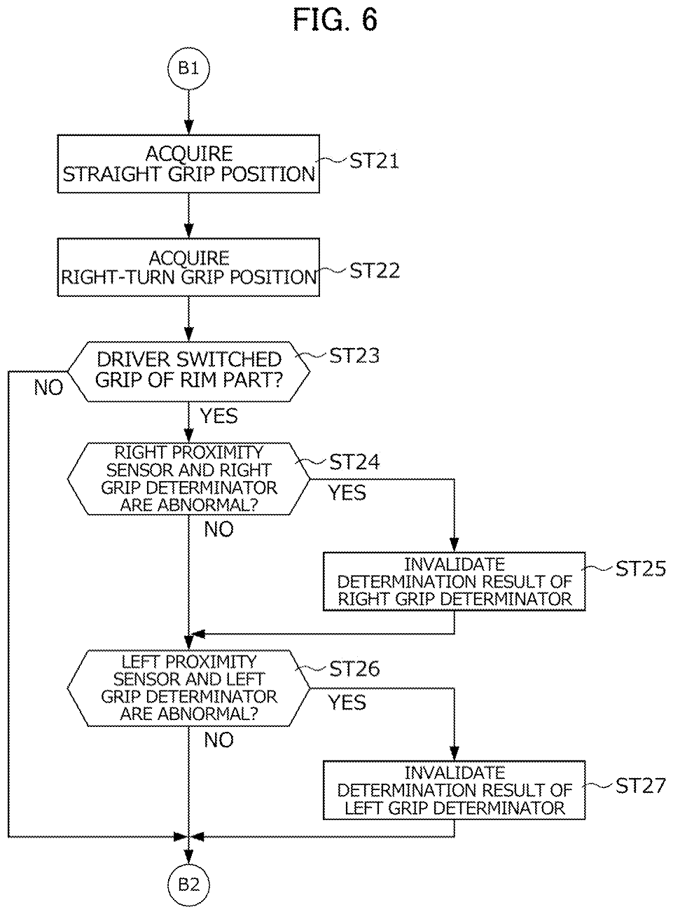

FIGS. 4 to 6 are flowcharts showing specific sequences of abnormality determination processing of determining the presence/absence of abnormality in the grip sensor unit 8 in the abnormality determination device 9. The processing shown in FIGS. 4 to 6 is repeatedly executed under a predetermined control cycle in the abnormality determination device 9, in response to the vehicle being started by the driver operating a start switch (not shown).

First, in Step ST1, the abnormality determination device 9 acquires the current steering angle detection value and gripping position from the steering angle sensor 31 and grip sensor unit 8, stores in a storage medium (not shown), and then the processing advances to Step ST2. Time-series data of the steering angle detection value and gripping position for every control cycle is thereby stored in the storage medium.

Next, in Step ST2, the abnormality determination device 9 determines whether the current steering angle detection value is at least a positive left-turn steering angle threshold set in advance. Herein, the left-turn steering angle threshold is set to the steering angle at which most drivers would start grip changing of the rim part 20 during left turn as shown in FIG. 3B. More specifically, the left-turn steering angle threshold is set to an angle distanced by at least 90° to the positive side from the neutral position, i.e. angle of at least 90°. The abnormality determination device 9 advances to Step ST3 in the case of the determination result in Step ST2 being NO, and advances to Step ST11 in the case of being YES.

Next, in Step ST3, the abnormality determination device 9 determines whether the current steering angle detection value is less than a negative right-turn steering angle threshold set in advance. Herein, the right-turn steering angle threshold is set to the steering angle at which most drivers would start grip change of the rim part 20 during right turn as shown in FIG. 3C. More specifically, the right-turn steering angle threshold is set to an angle distancing by at least 90° to the negative side from the neutral position, i.e. angle no more than −90°. The abnormality determination device 9 advances to Step ST21 in the case of the determination result in Step ST3 being YES, and returns to Step ST1 in the case of being NO.

In Step ST11, the abnormality determination device 9 acquires the grip position while going straight before the steering angle detection value exceeds the left-turn steering angle threshold as the straight grip position from the time-series data stored in Step ST1, and then advances to Step ST12. More specifically, the abnormality determination device 9 acquires, as the straight grip position, from among the above-mentioned time-series data, the grip positions of the moment when the steering angle detection value exceeded the threshold set to a value slightly greater than 0°, prior to the moment when the steering angle detection value first exceeded the left-turn steering angle threshold. In other words, the abnormality determination device 9 acquires, as the straight grip position, the grip position at the moment when the driver starts turning the steering wheel 2, which is at the neutral position, to the left-turn direction.

In Step ST12, the abnormality determination device 9 acquires, as the left-turn grip position, the gripping position during left turn after the steering angle detection value exceeded the left-turn steering angle threshold, from the time-series data stored in Step ST1, and then advances to Step ST13. More specifically, the abnormality determination device 9 acquires, as the left-turn grip position, the latest gripping position in the above-mentioned time-series data.

In Step ST13, the abnormality determination device 9 determines whether the driver changed grip of the rim part 20 while turning left, by comparing between the straight grip position and left-turn grip position. More specifically, the abnormality determination device 9 determines that the driver changed grip on the rim part 20 while turning left, in the case of the straight grip position and left-turn grip position differing, and determines that the driver is not changing grip on the rim part 20 while turning left in the case of the straight grip position and left-turn grip position matching. The abnormality determination device 9 advances to Step ST14 in the case of the determination result in Step ST13 being YES, and returns to Step ST1 in the case of being NO.

In Step ST14, the abnormality determination device 9 determines the presence/absence of abnormality in the right proximity sensor 4 and right grip determiner 80R of the grip sensor unit 8. More specifically, the abnormality determination device 9 determines that the right proximity sensor 4 and right grip determiner 80R are abnormal, in the case of the straight grip position including the right grip part 20R, and the left-turn grip position including both the right grip part 20R and the lower grip part 20D more to the right-turn direction side (clockwise side) than this right grip part 20R, and then advances to Step ST15. In other words, the abnormality determination device 9 determines that the right proximity sensor 4 and right grip determiner 80R are abnormal, in the case of being determined that the right grip part 20R is being gripped, irrespective of the driver switching grip of the right hand HR from the right grip part 20R to the lower grip part 20D. In addition, the abnormality determination device 9 determines that the right proximity sensor 4 and right grip determiner 80R are not abnormal in the case of straight grip position not including the right grip part 20R, or a case of the left-turn grip position not including both the right grip part 20R and lower grip part 20D, and then advances to Step ST16.

In Step ST15, the abnormality determination device 9 invalidates the determination result of the right grip determiner 80R thereafter, in response to being determined that the right proximity sensor 4 and right grip determiner 80R are abnormal, and then advances to Step ST16.

In Step ST16, the abnormality determination device 9 determines the presence/absence of abnormality in the left proximity sensor 5 and left grip determiner 80L of the grip sensor unit 8. More specifically, the abnormality determination device 9 determines that the left proximity sensor 5 and left grip determiner 80L are abnormal in the case of the straight grip position including the left grip part 20L, and the left-turn grip position including both the left grip part 20L and upper grip part 20U more to the right-turn direction side (clockwise side) than this left grip part 20L, and then advances to Step ST17. In other words, the abnormality determination device 9 determines that the left proximity sensor 5 and left grip determiner 80L are abnormal, in the case of being determined that the left grip part 20L is being gripped, irrespective of the driver switching grip of the left hand HL from the left grip part 20L to the upper grip part 20U. In addition, the abnormality determination device 9 determines that the left proximity sensor 5 and left grip determiner 80L are not abnormal in the case of the straight grip position not including the left grip part 20L, or the left-turn grip position not including both the left grip part 20L and upper grip part 20U, and then returns to Step ST1.

In Step ST17, the abnormality determination device 9 invalidates the determination result of the left grip determiner 80L thereafter, in response to being determined that the left proximity sensor 5 and left grip determiner 80L are abnormal, and then returns to Step ST1.

In Step ST21, the abnormality determination device 9 acquires, as the straight grip position, the gripping position while going straight prior to the steering angle detection value exceeding the left-turn steering angle threshold, from the time-series data stored in Step ST1, and then advances to Step ST22. More specifically, the abnormality determination device 9 acquires, as the straight grip position, the grip position at the moment when the steering angle detection value exceeded the threshold set to a value slightly smaller than 0°, earlier than the moment when the steering angle detection value first exceeded the right-turn steering angle threshold, from among the above-mentioned time-series data. In other words, the abnormality determination device 9 acquires, as the straight grip position, the gripping position at the moment when the driver first turned the steering wheel 2 at the neutral position to the right-turn direction.

In Step ST22, the abnormality determination device 9 acquires, as the right-turn grip position, the grip position while turning right after the steering angle detection value exceeded the right-turn steering angle threshold, from the time-series data stored in Step ST1, and then advances to Step ST23. More specifically, the abnormality determination device 9 acquires, as the right-turn grip position, the latest gripping position in the above-mentioned time-series data.

In Step ST23, the abnormality determination device 9 determines whether the driver switched grip of the rim part 20 while turning right, by comparing between the straight grip position and right-turn grip position. More specifically, the abnormality determination device 9 determines that the driver switched grip of the rim part 20 while turning right, in the case of the straight grip position and right-turn grip position differing, and determines that the driver is not switching grip of the rim part 20 while turning right, in the case of the straight grip position and right-turn grip position matching. The abnormality determination device 9 advances to Step ST24 in the case of the determination result in Step ST23 being YES, and returns to Step ST1 in the case of being NO.

In Step ST24, the abnormality determination device 9 determines the presence/absence of abnormality in the right proximity sensor 4 and right grip determiner 80R of the grip sensor unit 8. More specifically, the abnormality determination device 9 determines that the right proximity sensor 4 and right grip determiner 80R are abnormal, in the case of the straight grip position including the right grip part 20R and the right-turn grip position including both the right grip part 20R and upper grip part 20U which is more to the left-turn direction side (counter clockwise side) than this right grip part 20R, and then advances to Step ST25. In other words, the abnormality determination device 9 determines that the right proximity sensor 4 and right grip determiner 80R are abnormal, in the case of being determined that the right grip part 20R is being grip, irrespective of the driver having switched grip of the right hand HR from the right grip part 20R to the upper grip part 20U while turning right. In addition, the abnormality determination device 9 determines that the right proximity sensor 4 and right grip determiner 80R are not abnormal, in the case of the straight grip position not including the right grip part 20R, or the right-turn grip position not including both the right grip part 20R and upper grip part 20U, and then advances to Step ST26.

In Step ST25, the abnormality determination device 9 invalidates the determination result of the right grip determiner 80R thereafter, in response to being determined that the right proximity sensor 4 and right grip determiner 80R are abnormal, and then advances to Step ST26.

In Step ST26, the abnormality determination device 9 determines the presence/abnormality of abnormality in the left proximity sensor 5 and left grip determiner 80L of the grip sensor unit 8. More specifically, the abnormality determination device 9 determines that the left proximity sensor 5 and left grip determiner 80L are abnormal, in the case of the straight grip position including the left grip part 20L, and the right-turn grip position including both the left grip part 20L and the lower grip part 20D more to the left-turn direction side (counter clockwise side) than this left grip part 20L, and then advances to Step ST27. In other words, the abnormality determination device 9 determines that the left proximity sensor 5 and left grip determiner 80L are abnormal, in the case of being determined that the left grip part 20L is being gripped, irrespective of the driver switching grip of the left hand HL from the left grip part 20L to the lower grip part 20D. In addition, the abnormality determination device 9 determines that the left proximity sensor 5 and left grip determiner 80L are not abnormal, in the case of the straight grip position not including the left grip part 20L, or in the case of the right-turn grip position not including both the left grip part 20L and lower grip part 20D, and then returns to Step ST1.

In Step ST27, the abnormality determination device 9 invalidates the determination result of the left grip determiner 80L thereafter, in response to being determined that the left proximity sensor 5 and left grip determiner 80L are abnormal, and then returns to Step ST1.

According to the steering device 1 related to the present embodiment, the following effects are exerted.
(1) The grip sensor unit 8 measures the electrostatic capacitance of the plurality of electrodes 40 to 70 provided to the steering wheel 2, acquires the presence/absence of gripping of the steering wheel 2 and gripping position by the driver, based on the measurement results of these electrostatic capacitances, and the abnormality determination device 9 determines the presence/absence of abnormality in the grip sensor unit 8. Herein, the driver often changes grip of the steering wheel 2 from when going straight to when turning, upon rotating the steering wheel 2 in the left-turn direction or right-turn direction for turning the vehicle. In other words, the gripping position while going straight before the steering angle detection value of the steering wheel 2 exceeds the left-turn steering angle threshold or right-turn steering angle threshold often differs from the gripping position while turning after the steering angle detection value has exceeded the left-turn steering angle threshold or right-turn steering angle threshold. Therefore, the abnormality determination device 9 determines the presence/absence of abnormality in the grip sensor unit 8, based on the straight grip position, and the left-turn grip position or right-turn grip position. Consequently, according to the steering device 1, it is possible to quickly determine the presence/absence of abnormality in the grip sensor unit 8 of the steering wheel 2 with a simple configuration, and can contribute to the development of a sustainable transportation system.
(2) When switching grip of the steering wheel from when going straight to when turning as mentioned above, the gripping position often differs between when going straight and when turning. Therefore, the abnormality determination device 9, for example, determines that the grip sensor unit 8 is abnormal, in a case of the gripping position of the right hand HR while going straight being the right grip part 20R and the gripping position of the right hand HR while turning left including both the right grip part 20R and lower grip part 20D, i.e. the right grip part 20R being gripped also while turning left, irrespective of the gripping position of the right hand HR changing from the right grip part 20R to the lower grip part 20D from while going straight to while turning left. Consequently, according to the steering device 1, it is possible to quickly determine the presence/absence of abnormality in the grip sensor unit 8 of the steering wheel 2 with a simple configuration.
(3) In the case of switching grip of the steering wheel 2 as mentioned above, the driver often changes the gripping position on the annular rim part 20 from while going straight to while turning to the opposite side than the turning direction, in order to reduce the extension of one's arm and the twist of the wrist, and avoid interference between the elbow and torso. In other words, in the case of rotating the rim part 20 while turning left counter clockwise, the driver often changes the gripping position of the right hand HR to the lower grip part 20D distancing clockwise from the right grip part 20R while going straight. In other words, in the case of rotating the rim part 20 clockwise while turning right, the driver often changes the gripping position of the right hand HR to the upper grip part 20U distancing counter clockwise from the right grip part 20R while going straight. Therefore, the abnormality determination device 9, for example, determines that the grip sensor unit 8 is abnormal, in the case of the gripping position of the right hand HR while going straight being the right grip part 20R, and the gripping position of the right hand HR while turning left including both the right grip part 20R and the lower grip part 20D, which is decided more to the opposite side to the left-turn direction than this right grip part 20R. Consequently, according to the steering device 1, it is possible to quickly determine the presence/absence of abnormality in the grip sensor unit 8 of the steering wheel 2 with a simple configuration.
(4) The grip sensor unit 8 includes: the right electrode 40 provided at a position close to the right grip part 20R; the lower electrode 70 provided at a position close to the lower grip part 20D; the right grip determiner 80R which determines the presence/absence of gripping of the right grip part 20R based on the measurement result of electrostatic capacitance of the right electrode 40; and the lower grip determiner 80D which determines the presence/absence of gripping of the lower grip part 20D based on the measurement result of electrostatic capacitance of the lower electrode 70. In addition, the abnormality determination device 9 determines that there is an abnormality in the right grip determiner 80R of the grip sensor unit 8, in the case of the gripping position of the right hand HR while going straight being the right grip part 20R, and the gripping position of the right hand HR while turning left including both the right grip part 20R and the lower grip part 20D, and then invalidates the determination results of the right grip determiner 80R thereafter. It is thereby possible to guarantee reliability of determination results of the grip sensor unit 8 after being determined that an abnormality occurred.
(5) The driver often switches grip of the steering wheel 2 while rotating the steering wheel 2 from the neutral position by at least 90° to the left-turn direction or right-turn direction. Therefore, with the steering device 1, it is possible to precisely determine abnormality in the grip sensor unit 8, by setting the left-turn steering angle threshold and right-turn steering angle threshold to an angle distancing at least 90° from the neutral position.

Although an embodiment of the present invention has been explained above, the present invention is not to be limited thereto. The configurations of detailed parts may be modified where appropriate within the scope of the gist of the present invention.

For example, the above embodiment divides the rim part 20 into the four grip parts 20R, 20L, 200, 20D, and the grip sensor unit 8 determines the presence/absence of gripping of each grip part 20R, 20L, 200, 20D based on the measurements results of electrostatic capacitance of each electrode 40, 50, 60, 70 provided near the respective grip parts 20R, 20L, 20U, 20D; however, the present invention is not limited thereto. In other words, the positions at which providing the respective electrodes are not limited to the rim part 20, and may be provided at the spokes 25L, 25R, 25D and/or hub part 23. In addition, the number of electrodes provided to the steering wheel 2 is not limited to four, and may be five or more.

What is claimed is:

1. A steering device comprising:
a steering wheel which accepts a steering operation of a vehicle from a driver;
a steering angle acquirer which acquires a steering angle of the steering wheel;
a grip sensor unit which measures electrostatic capacitance of an electrode provided to the steering wheel, and acquires presence/absence of gripping of the steering wheel and gripping position by a driver based on a measurement result of the electrostatic capacitance; and
an abnormality determination device which determines presence/absence of abnormality in the grip sensor unit,
wherein the abnormality determination device determines presence/absence of abnormality in the grip sensor unit based on the gripping position while going straight prior to the steering angle exceeding a predetermined steering angle threshold, and the gripping position while turning after the steering angle exceeded the steering angle threshold.

2. The steering device according to claim 1, wherein the abnormality determination device determines that the grip sensor unit is abnormal, in a case of the gripping position while going straight being a first position, and the gripping position while turning including both the first position and a second position differing from the first position.

3. The steering device according to claim 2, wherein the steering wheel includes an annular rim part, a hub part provided at an inner side of the rim part, and a spoke connecting the rim part and the hub part,
wherein the grip sensor unit acquires the gripping position on the rim part, and
wherein the second position is decided more to an opposite side to a turning direction than the first position on the rim part.

4. The steering device according to claim 3, wherein the grip sensor unit includes:
a first electrode provided to the steering wheel;
a second electrode provided at a position on the steering wheel farther from the first position than the first electrode and closer to the second position;
a first grip determiner which determines presence/absence of gripping at the first position on the rim part based on a measurement result of electrostatic capacitance of the first electrode; and
a second grip determiner which determines presence/absence of gripping at the second position on the rim part based on a measurement result of electrostatic capacitance of the second electrode,
wherein the abnormality determination device invalidates determination result of the first grip determiner, in a case of the gripping position while going straight being the first position and the gripping position while turning including both the first position and the second position.

5. The steering device according to claim 1, wherein the steering angle threshold is set to an angle distanced by at least 90° from a neutral position.

6. The steering device according to claim 2, wherein the steering angle threshold is set to an angle distanced by at least 90° from a neutral position.

7. The steering device according to claim 3, wherein the steering angle threshold is set to an angle distanced by at least 90° from a neutral position.

8. The steering device according to claim 4, wherein the steering angle threshold is set to an angle distanced by at least 90° from a neutral position.
